(19) United States
(12) Patent Application Publication
(10) Pub. No.: US 2007/0160943 A1
(43) Pub. Date: Jul. 12, 2007

(54) Monolith for use in regenerative oxidizer systems

(76) Inventor: David Lex, Akron, OH (US)

Correspondence Address: ROETZEL AND ANDRESS, 222 SOUTH MAIN STREET, AKRON, OH, 44308, US

(21) Appl. No.: 10/565,891

(22) PCT Filed: Jul. 30, 2004
(86) PCT No.: PCT/US04/24688

§ 371 Date: Nov. 3, 2006

Related U.S. Application Data
(60) Provisional application No. 60/492,173, filed on Aug. 1, 2003.

(51) Int. Cl. F23D 11/44; B01J 21/04

(52) U.S. Cl. 431/215; 502/439

(57) ABSTRACT

A ceramic packing element comprising a monolith structure having a generally block shape and having plurality of equally spaced parallel openings therein extending the length of the block where the openings have generally straight sides and corners which are rounded. The corners are substantially radiused to produce the rounded corners. For example, where the openings in the element are between 1.8 and 6.5 mm, the radius will be between 0.3 and 1.8 mm. The block element will have between 20 to 60 cells by 20 to 60 cells totaling between 400 to 3600 cell elements.

### BACKGROUND OF THE INVENTION

The present invention is related to ceramic monoliths like those used in regenerative oxidizer systems. In particular, the invention is directed to a particular configuration of opening in the monolith.

Regenerative thermal oxidizers (RTO's) are known for oxidizing pollutants, such as hydrocarbon vapors in air, and converting the pollutants into carbon dioxide and water vapor. Typically, a pollutant laden “dirty” gas to be cleaned is directed into a combustion chamber and through a previously heated regenerative heat exchanger. At the same time, a previously combusted hot “clean” gas is directed out of the combustion chamber and into a second heat exchanger where incoming gas yet to be cleaned is heated as it passes through the previously heated heat exchanger. Meanwhile, the gas that has been combusted is passing out through the second heat exchanger and heats the second heat exchanger. Thus, regenerative thermal oxidizers continuously operate to combust or oxidize a gas to be cleaned. By alternating the flow of cool gas to be cleaned through a hot heat exchanger, then moving hot gas from the combustion chamber outwardly through a heat exchanger, each heat exchanger is periodically and alternatively heated and cooled.

Regenerative thermal beds have been used to capture and store heat from a first hot stream of fluid and then to transfer the heat to a second cold body of fluid before it is reacted such as by combustion, oxidation, reduction or other chemical process whether reacted in the presence or absence of a catalyst.

Originally river gravel was used as the packing for the bed. Later systems utilized small pieces of ceramic material as heat exchange media, such as one-inch ceramic saddle-shaped pieces, irregular mineral spheroids or gravel, and Raschig rings. The saddles or spheroids are poured into a regenerator shell and raked to a uniform depth. The individual pieces of the heat exchange media remain in whatever orientation they happen to fall into when the regenerator shell is filed. The resistances to gas flows or pressure drop through the heat exchange media is relatively high and will vary through the heat exchange media, depending upon the random orientation of the media and, to some extent, the degree of contamination. Furthermore, the locally blocked areas may trap fluid that can contaminate the flow of second fluid or can be exhausted to the environment. In a typical regenerator having randomly oriented saddle-shaped pieces, the overall pressure drop will be about twenty inches of water, or greater.

The use of monolithic columns of ceramic material for the heat exchanger columns in a regenerative thermal oxidizer system for cleaning combustion gas has been disclosed in U.S. Pat. Nos. 5,352,115; 5,531,593; 5,707,229; and 5,851,636 to Klobucar. The monolithic columns have a lower pressure drop and reduce contamination experienced with random packing of saddles or rings. Another example, is U.S. Pat. Nos. 5,851,636 and 6,071,593 to Lang et al. Further, European patent publication EP 0472605 to Kanzler et al discloses a RTO system which uses regenerators formed with an essentially prismatic heat-accumulator body where the prism extends substantially parallel to the main axis of the prism and are, preferably, rectangular or square.

Additionally, monolithic columns can carry a layer of catalyst for use in catalytic processes to synthesize or convert gaseous streams to other products and in the treatment of exhaust gases from combustion engines or from industrial processes. The ceramic columns are coated with catalyst materials, such as rare earth metals.

### SUMMARY OF THE INVENTION

The present invention is the result of the discovery that a ceramic packing element comprising a monolith structure having a generally block shape and having plurality of equally spaced parallel openings therein extending the length of the block can be improved by the openings having generally straight sides and corners which are rounded. The corners are significantly rounded or radiused to produce the rounded corners. For example, where the openings in the element are between 1.8 and 6.5 mm, the radius will be between 0.3 and 1.8 mm. Further, the block element will have between 20 to 60 cells by 20 to 60 cells totaling between 400 to 3600 cell elements. The design reduces the dead areas in the cells and prevents solids from accumulating in the corners and plugging the cells.

### BRIEF DESCRIPTION OF THE DRAWINGS

FIG. 1 shows a cross-sectional view of a block in accordance with the present invention;

FIG. 2 is a graph showing heat transfer of a block in accordance with the present invention and which has been analyzed using Computational Fluid Dynamics; and

FIG. 3 is a graph showing heat transfer of a prior art “square opening” block and which has been analyzed using Computational Fluid Dynamics.

### DETAILED DESCRIPTION OF THE INVENTION

The present invention is to a ceramic packing element comprising a monolith structure having a generally block shape and having plurality of equally spaced parallel openings therein extending the length of the block and having generally straight sides and corners which are rounded. The corners are significantly rounded or radiused to produce the rounded corners. Thus, where the openings in the element are between 1.8 and 6.5 mm, the radius will be between 0.3 and 1.8 mm. This will give a radius ratio, i.e., the ratio of the radius to the opening size of about 0.15 to about 0.30, preferably between about 0.166 and about 0.277. So, a significantly rounded corner will be one having a radius ratio of greater than 0.15.

The block element will have between 20 to 60 cells by 20 to 60 cells totaling between 400 to 3600 cell elements. The spacing between the openings is not critical other than to achieve the appropriate strength and performance as is shown in the art. So the spacing could range from 0.25 mm to 5.0 mm, with 0.3 mm to 3.0 mm being preferred. The outer walls may have the same dimensions as the spacing between the openings or could be larger or smaller depending upon the strength and performance desired, again, as is known in the art. Usually, the outer walls will be larger. For example, if the cell wall thickness is 1.5 mm, then the outer walls might be 3.0 mm. Further, the corners of the outer walls of the blocks can also be squared or curved, although it is not critical. Some curvature may be desired for ease of manufacture and to reduce manufacturing costs.

The monoliths of the invention contain about the same amount of ceramic material as an equivalently sized monolithic element. The monoliths can be produced by stamping, casting, extrusion, or combinations of these processes or can be assembled from plates. For example, the plates can be cut into the desired shape and stacked in the green or fired state into the shape of an element. The elements formed from green, uncured plates are manufactured by firing the stack of green plates. The ceramic plates and/or elements are generally formed from refractory clays generally containing such constituents as SiO₂, Al₂O₃, MgO, CaO, K₂O₂, etc. The ceramic element is inert to the gases passing through the regenerative heat exchanger and remains solid at the highest temperature achieved during the process. Therefore, it is preferred that the monoliths are made from acid or alkali resistant materials, which are also thermal shock resistant. Such materials could be made from corderite, mullite, sapanite, porcelain, and/or stoneware. It is also preferred that it be iron-free. Further, it may be desirable to incorporate lithium for thermal shock resistance.

As an example, a ceramic monolith or packing element was made having the following characteristics:

| | |
|---|---|
| Overall dimension | 150 × 150 × 300 mm Block |
| Outer wall thickness | 3.0 mm |
| Cell wall thickness | 1.5 mm |
| Total number of cells/Block | 22 × 22 (484 cells) |
| % Open Face | 53.0% |
| Geometric Surface Area (GSA) | 123 ft²/ft³ (404 m²/m³) |

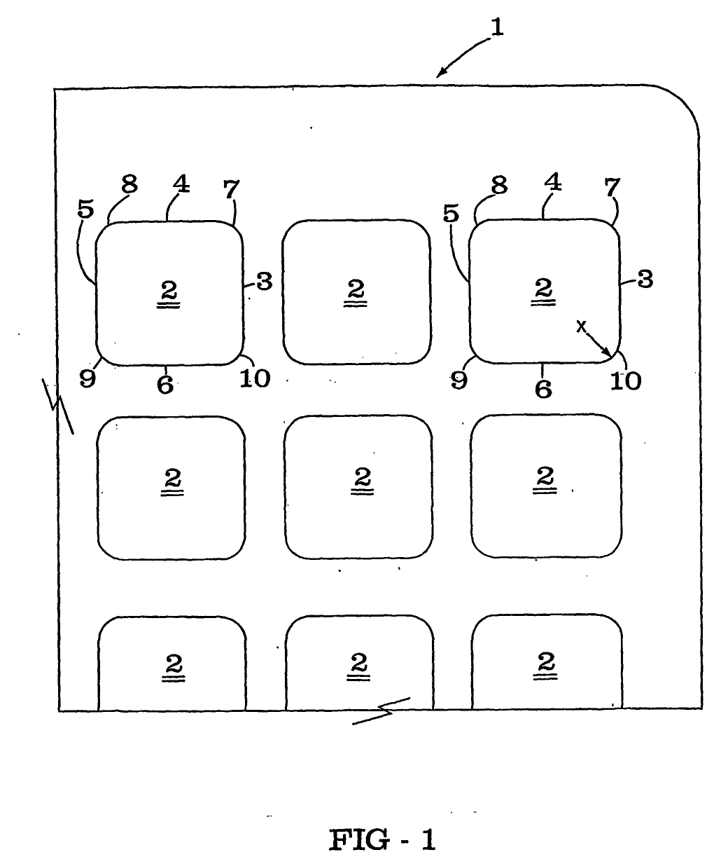

As can be seen in FIG. 1 which shows a partial cross-sectional view of a monolith, 1, having a plurality of cells or openings, 2. The walls, 3, 4, 5 and 6, of the openings define a rectangular shape and are generally straight, while the corners of the individual cell, 7, 8, 9, and 10, are curved. In this example, the curvature has a radius of 1.5 mm. This curvature at the corners of the cells make the cells look like they are rounded, but the cells are not totally circular. This pronounced curvature within each cell, not only will reduce the stresses due to the drying or firing of the greenware, but also will maximize the useful surface for heat transfer to take place during their use in RTO systems. Hence, it will enhance the percent Thermal Energy Recovery when compared to squared-shaped monolith of the similar Geometric Surface Area (GSA). Also, with reduced stress loads at the corner of the cells as well as the axial stresses, this monolith will endure severe thermal cyclings in RTO applications. The blocks were then analyzed for enhancement of the heat transfer has been analyzed using Computational Fluid Dynamics (CFD) technique and were compared to the “squared-cell” monoliths of the same dimensions.

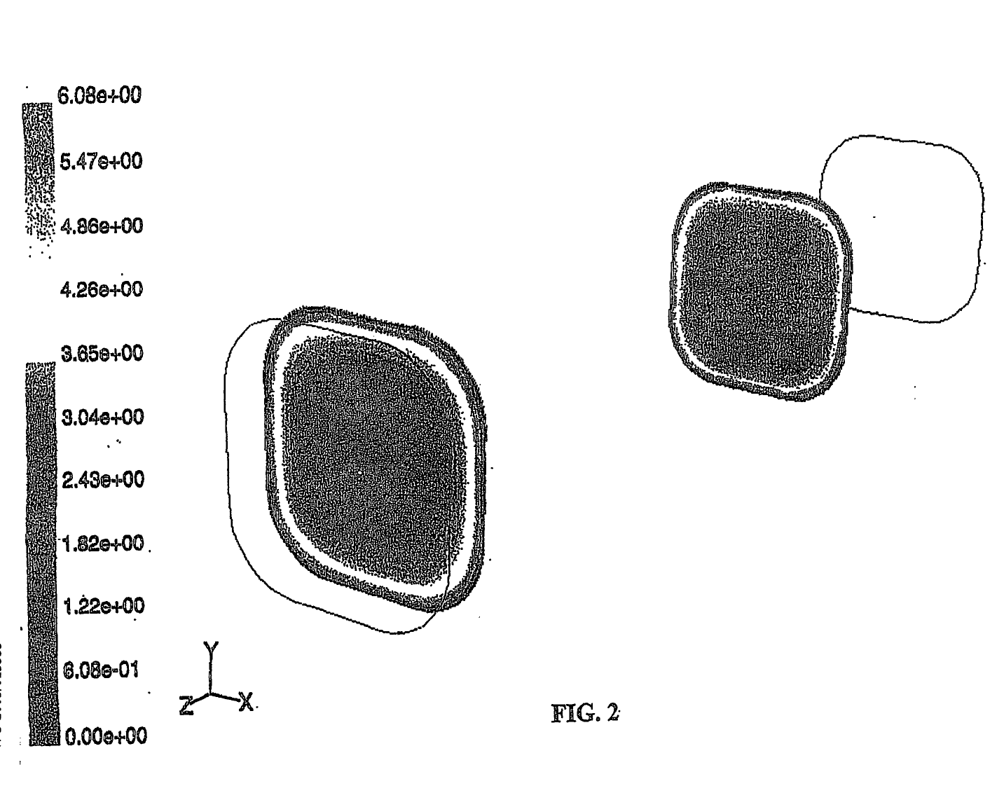

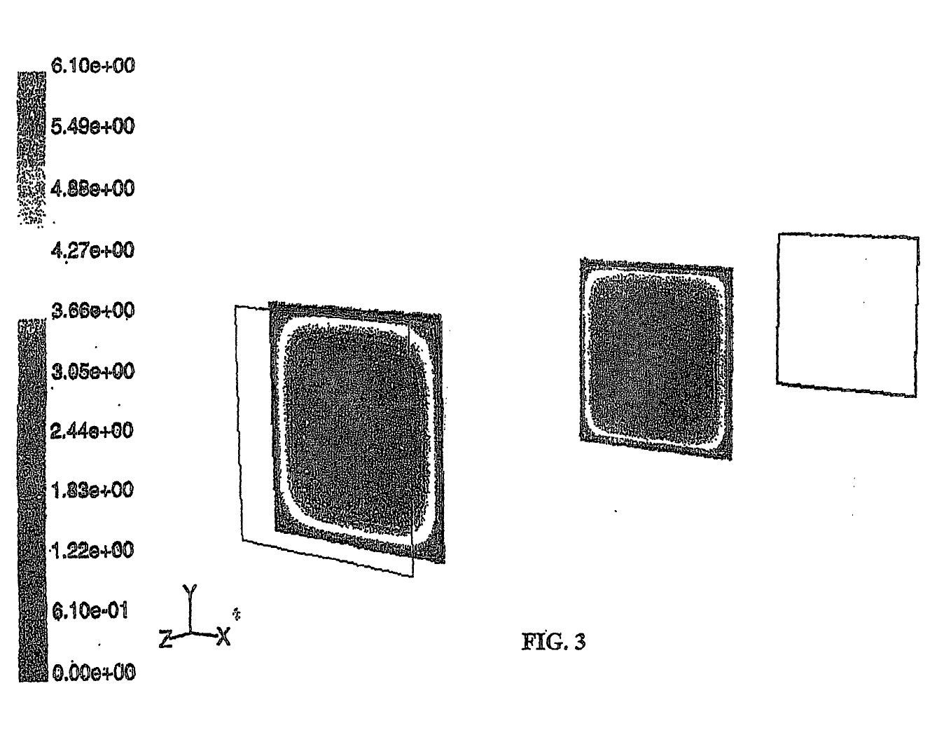

In the CFD study, the results of which are shown in FIGS. 2 and 3, two cells of the same size, one squared shaped and other one with the rounded corners are chosen. The study was based on 250 standard feet per minute gas velocity, inlet gas temperature of 100° F., and a constant heat flux of 10,000 BTU/h.ft² introduced in the body of the ceramic cells. In the case of squared-cell monolith, a good portion of the cell at the corners don't experience any heat transfer from gas any heat transfer from gas phase to the solid phase or vise versa. The flow is stagnant at the corners of the cell. Therefore, a very little heat transfer takes place at the corners. A larger low temperature contour at the center (blue color) is a very good indicative of this claim.

As can be seen from FIGS. 2 and 3, it is predicted that during performance in regenerative thermal oxidation applications, when compared to 25×25 cell monolith, the proposed thermal shock resistant monolith will have about 5 to 10% higher pressure drop, but about 1 to 2% extra Thermal Energy Recovery. Further, one layer of the rounded cell monoliths, in accordance with the present invention, at the hot zone and 3 layers of 40×40 cell monolith will have at least 95% Thermal Energy Recovery and about 4 in H₂O pressure drop at 250 SFPM gas velocity.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated. It is intended that the invention be defined by the following claims.

What we claim is:

1. A ceramic packing element comprising:
a monolith structure having a generally block shape and having plurality of equally spaced parallel openings therein extending the length of the block where the openings have generally straight sides and have significantly rounded corners having a radius of between about 0.3 mm and 1.8 mm.

2. The ceramic packing element of claim 1 wherein the openings are between about 1.8 and 6.5 mm.

3. The ceramic packing element of claim 1 wherein the structure has between 20 to 60 cells by 20 to 60 cells totaling between 400 to 3600 cell elements.

4. The ceramic packing element of claim 1 wherein the geometric surface area is between about 300 m²/m³ and 1310 m²/m³.

5. The ceramic packing element of claim 1 wherein the geometric surface area is about 400 m²/m³.

6. The ceramic packing element of claim 1 wherein the openings have a radius ratio of greater than 0.15.

7. The ceramic packing element of claim 1 wherein the openings have a radius rotation of 015 to 0.30.

8. A regenerative thermal oxidizer comprising:
A. a combustion chamber including a burner;
B. at least two heat exchangers, each having a heat exchanger passage leading into said combustion chamber and having a heat transfer column located therein; an inlet line connected to a source of gas to be cleaned having entrained pollutants and communicating with an inlet branch leading to each of said heat exchangers with an inlet valve located in each inlet branch;
C. an outlet line leading from each heat exchanger, each outlet line including an outlet valve, and an outlet branch communicating with each said outlet line; gas to be cleaned being delivered through said inlet line into one of said heat exchangers by opening of said inlet valves and closing said outlet valve on said one heat exchanger, gas moving through said heat exchanger and into said combustion chamber where said gas is combusted, the combusted clean gas then being led into a second heat exchanger having a closed inlet valve and an open outlet valve, the gas then being delivered to said outlet line; and
D. said heat transfer column including a solid body formed of heat resistant, heat retaining material having a plurality of spaced axial gas flow passages, said passages having a substantially constant cross-sectional area with generally straight sides and significantly rounded corners having a radius of about 0.3 to 1.8 mm, the pressure drop across the heat transfer column being less than 5 inches of water when the superficial flow rate is greater than 100 feet per minute.
